(19) United States
(12) Patent Application Publication
(10) Pub. No.: US 2018/0249833 A1
(43) Pub. Date: Sep. 6, 2018

(54) SLIDE-IN DEVICE FOR MOVEABLE FURNITURE PARTS

(71) Applicant: Julius Blum GmbH, Hoechst (AT)

(72) Inventor: Christof GOETZ, Lustenau (AT)

(21) Appl. No.: 15/969,323

(22) Filed: May 2, 2018

Related U.S. Application Data
(63) Continuation of application No. PCT/AT2016/060063, filed on Sep. 16, 2016.

(30) Foreign Application Priority Data
Nov. 20, 2015 (AT) A 750/2015

(51) Int. Cl. A47B 88/467; A47B 88/437; A47B 88/49; E05F 1/16

(52) U.S. Cl. CPC A47B 88/467; A47B 88/437; E05Y 2900/20; E05F 1/16; E05Y 2800/24; A47B 88/49

(57) ABSTRACT

A retraction device includes an entrainment member to be releasably coupled to the movable furniture part, and a spring device for applying a force to the entrainment member in a direction opposite to an extension direction of the entrainment member. The spring device can be tensioned in the extension direction of the entrainment member by a spring holder separate from the entrainment member. A coupling device can couple a movement between the entrainment member and the spring holder, and can vary the distance of a fastening location of the spring device relative to the entrainment member upon extending the entrainment member towards the extension direction. The coupling device includes a control element having a longitudinal axis extending in the extension direction. To vary the distance between the fastening location and the entrainment member, the control element pivots about the longitudinal axis upon extending the entrainment member towards the extension direction.

The present invention relates to a retraction device for retracting a movably-mounted furniture part into a closed end position relative to a furniture carcass, including:
an entrainment member which can be releasably coupled to the movable furniture part,
at least one spring device for applying a force to the entrainment member in a direction opposite to an extension direction of the entrainment member, wherein the spring device can be tensioned in the extension direction of the entrainment member by a spring holder which is separate from the entrainment member,
a coupling device for coupling a movement between the entrainment member and the spring holder, wherein by the coupling device, the distance of a fastening location of the spring device on the spring holder relative to the entrainment member varies upon extending the entrainment member towards the extension direction.

The invention further relates to a drawer pull-out guide having a retraction device of the type to be described and an arrangement with a movably-mounted furniture part, in particular a flap, a door or a drawer, with such a retraction device for retracting the movable furniture part into a closed end position relative to a furniture carcass.

Retraction devices, in particular, are used in connection with drawers or sliding doors which are freely displaceable over a large part of their extension path and engaged by the entrainment member of the retraction device at the end of the closing movement, and are pulled by a spring force into the closed end position and are being held there with a predetermined closing force. Upon opening the movable furniture part, an operator firstly has to apply a force against the spring resistance of the retraction device, by pulling, until after a predetermined distance, the entrainment member is decoupled from the movable furniture part and is moved into a prestressed parking position in which the spring remains in a stressed ready position, so that in the next closing process, the movable furniture part can be pulled in again. For an operator, decoupling of the entrainment member in the opening movement for the drawer frequently makes itself noticeable with a jerky movement and with a clicking noise as, as a consequence of the sudden spring separation force, the drawer is freely movable and is accelerated unduly towards the opening direction by virtue of the previously exerted pulling force.

WO 2011/150432 A1 to the present applicant solves this problem by a spring holder which is separate from the entrainment member, and the spring holder is displaceably guided along a control curve. The entrainment member and the spring holder are thereby motionally coupled to one another by a coupling device in the form of interengaging tooth arrangements. Upon tensioning the spring device (i.e. upon opening the movable furniture part), the fastening location of the spring device on the spring holder falls back relative to the position of the entrainment member moving towards the extension direction, so that the movement of the fastening location of the spring device results slower than the movement of the entrainment member. The stressing of the spring device is thereby effected with reduced effort, and the undesired spring separation force and an unduly acceleration of the movable furniture part can be avoided when the movable furniture part is decoupled from the entrainment member. A drawback of this construction is that the installation height of the retraction device is to be dimensioned relatively large due to the interengaging tooth arrangements.

It is an object of the present invention to propose a retraction device of the type mentioned in the introductory part, having a more compact construction.

This is accomplished by the features as recited in claim 1. Further advantageous embodiments of the invention are defined in the dependent claims.

According to the invention, it is provided that the coupling device includes at least one control element having a longitudinal axis extending in the extension direction, wherein for varying the distance which is present between the fastening location and the entrainment member, the control element pivots at least partially about the longitudinal axis upon extending the entrainment member towards the extension direction.

Accordingly, for coupling a movement between the entrainment member and the fastening location of the spring device on the spring holder, a coupling device configured as a force reduction mechanism is provided, wherein the coupling device includes a control element which pivots about an own longitudinal axis as the entrainment member is being pulled outwardly. As a result, when the entrainment member is being pulled outwardly, the control element is forced to be moved with a movement component transverse to the extension direction of the entrainment member, so that the distance between the entrainment member and the fastening location is enlarged and the movement of the fastening location, upon extending the entrainment member, is decelerated relative to the entrainment member moving towards the extension direction.

By a pivotal movement of the control element about its own axis, the control element is guided with a component transverse to the extension direction of the entrainment member, so that the control element—with respect to the extension direction—covers less path than the entrainment member moving towards the extension direction. By the helical-shaped movement of the control element and the constant extension in space of the control element connected therewith, a very compact design of the retraction device is produced.

The control element can include at least one first guide element which, when the entrainment member is being pulled outwardly towards the extension direction, is guided, at least over a region, along a first guide track. Thereby, the first guide track can include a first section extending in the extension direction of the entrainment member and a helical-shaped second section adjoining the first section.

By the first section extending in the extension direction, the fastening location of the spring device, starting from the retracted end position of the entrainment member, can initially be moved with the same speed as the entrainment member towards the extension direction. By the helically-shaped second section (which has a component transverse to the extension direction of the entrainment member), the fastening location of the spring device on the spring holder falls back relative to the position of the moving entrainment member, so that at the end of the extension path of the entrainment member, the fastening location of the spring device on the spring holder is slower than the movement of the entrainment member. The pitch of the second section of the first guide track determines the degree of deceleration of the fastening location relative to the entrainment member.

By guiding the fastening location of the spring device along the helically-shaped second section, a continued, decelerated movement of the fastening location relative to the entrainment member moving towards the extension direction can be brought about, so that the spring device is not tensioned to its maximum extent. In order for the spring to be stressed, less physical effort is therefore required, wherein the transition region and the load change, respectively, between the coupled and the decoupled position of the entrainment member can be harmonized, i.e. the undesired spring separation force and an undesired acceleration of the movable furniture part upon decoupling the entrainment member can be avoided therewith.

Further details and advantages of the invention will be explained with the aid of the following description of figures, in which:

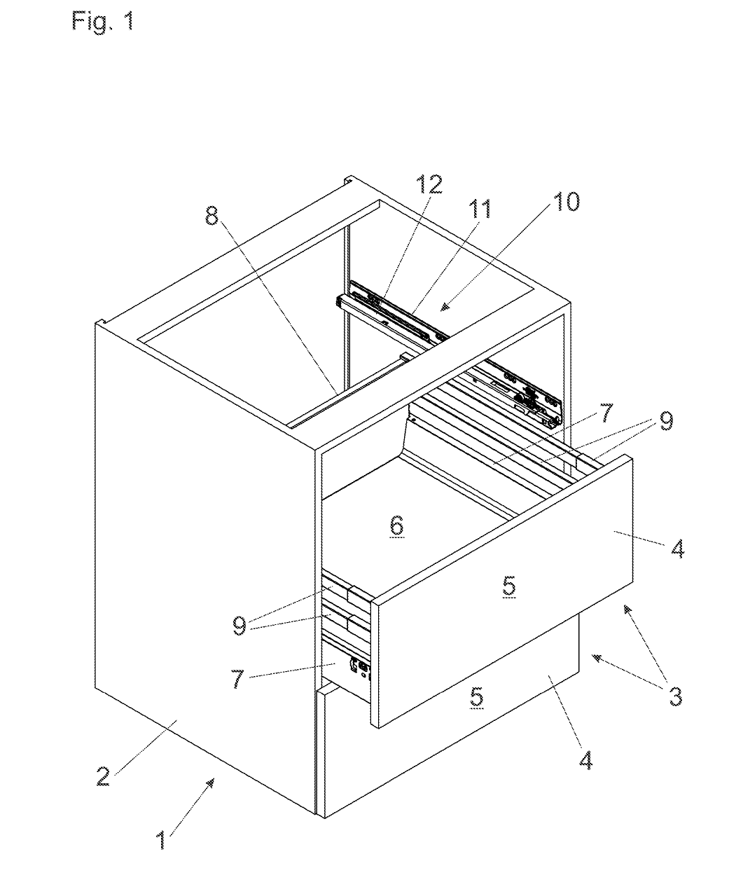

FIG. 1 shows a perspective view of an item of furniture having a furniture carcass and drawers movably mounted relative thereto,

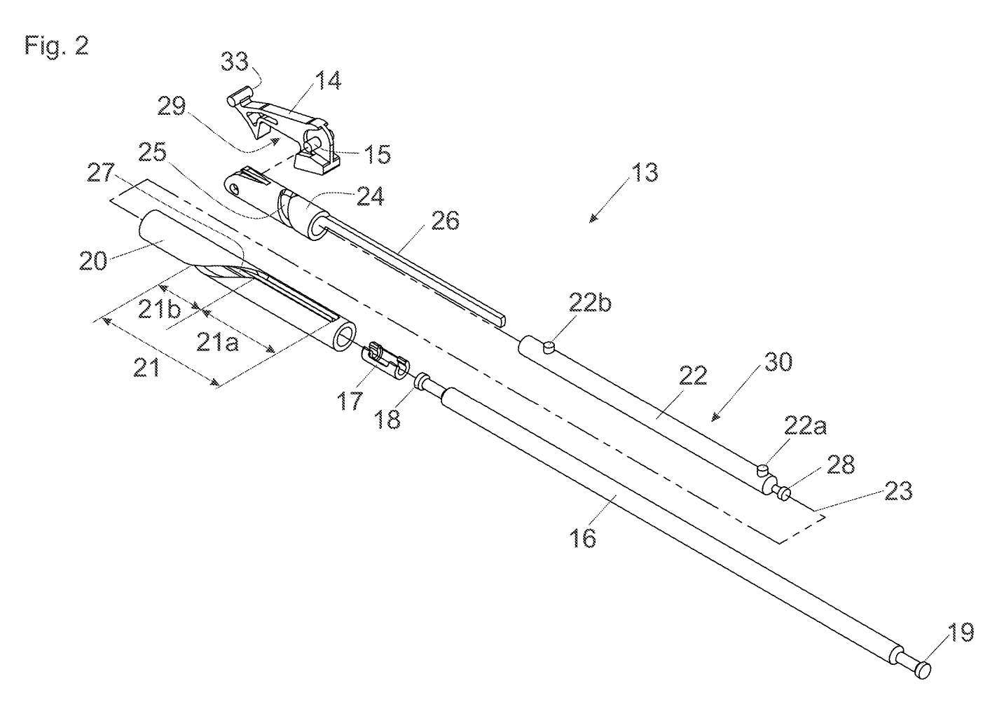

FIG. 2 shows an exploded view of a retraction device for retracting a movably-mounted furniture part into a closed end position relative to a furniture carcass,

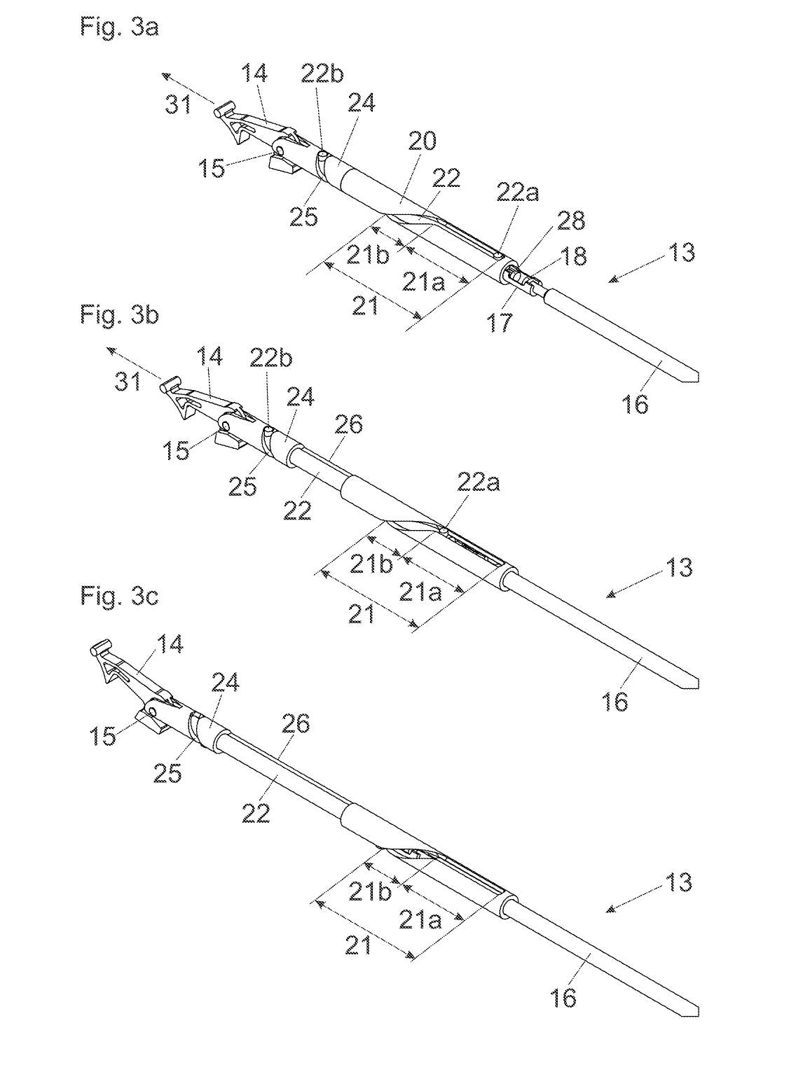

FIG. 3a-3c show perspective views of the retraction device with different positions of the entrainment member in the extension direction,

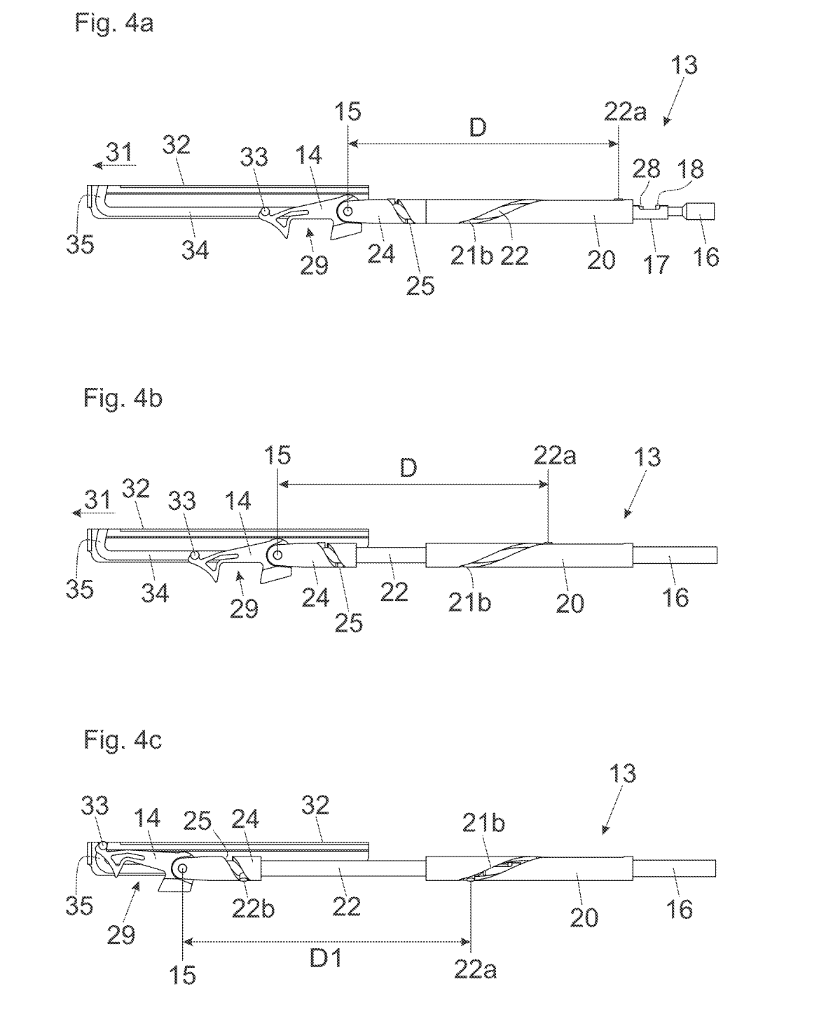

FIG. 4a-4c show side views of the retraction device with different positions of the entrainment member in the extension direction,

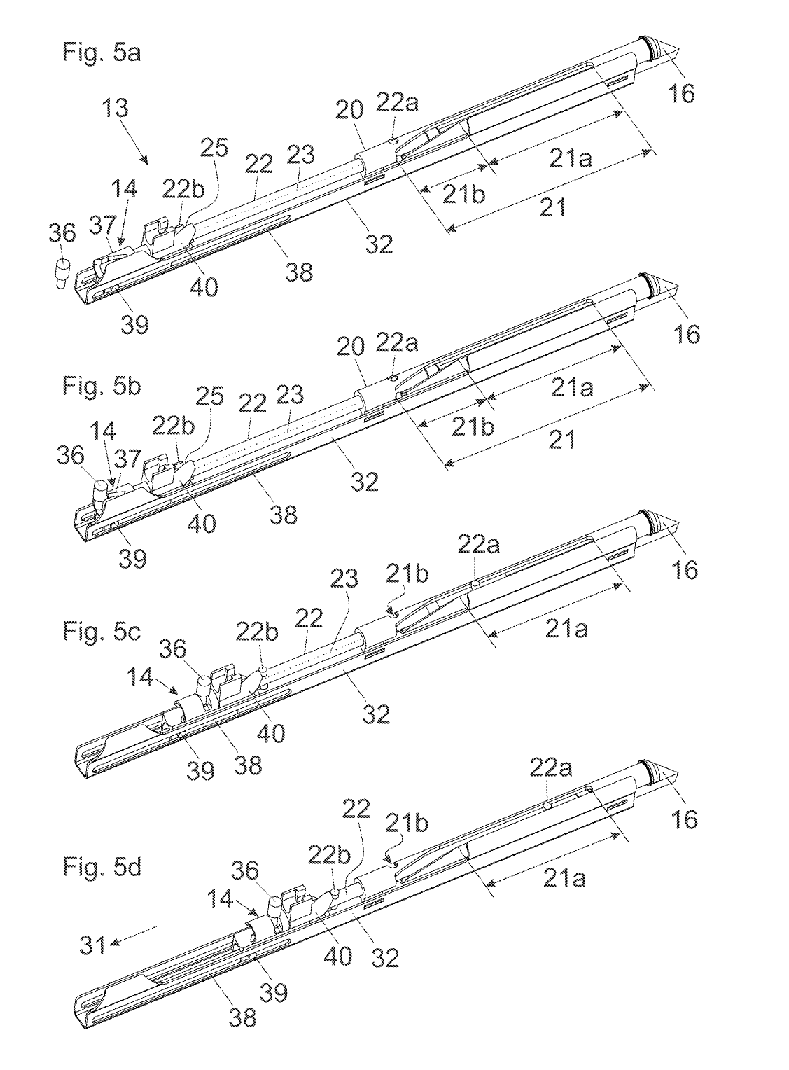

FIG. 5a-5d show a further embodiment of a retraction device having a pivotally mounted entrainment member in different retracting positions.

FIG. 1 shows an item of furniture 1 having a cupboard-shaped furniture carcass 2 and furniture parts 3 in form of drawers 4 which are movably-mounted relative to the furniture carcass 2. The drawers 4 each have a front panel 5, a drawer base 6, side walls 7 and a rear wall 8. Above the side walls 7, struts 9 are provided which extend between the front panel 5 and the rear wall 8 and which are provided for increasing the loading capacity of the drawer 4. For the displaceable support of the drawers 4 relative to the furniture carcass 2, drawer pull-out guides 10 are provided. The drawer pull-out guides 10 each have a carcass rail 11 to be fixed to the furniture carcass 2 and at least one extension rail 12 which is to be connected to the drawer 4 and which is displaceable relative to the stationary carcass rail 11. An additional displaceable central rail may be arranged between the carcass rail 11 and the extension rail 12 in order to enable a full extension for the drawer 4. Such a full extension is the case when the rear wall 8, in the fully extended position of the drawer 4, is arranged substantially flush with the front face of the furniture carcass 2.

FIG. 2 shows an exploded view of a retraction device 13 by which a movably-mounted furniture part 3 can be retracted into the closed end position relative to the furniture carcass 2. The retraction device 13 includes—as commonly known—an entrainment member 14 which is tiltably mounted about an axis 15 and which can be releasably coupled to the movable furniture part 3. For this purpose, the entrainment member 14 has a notch 29 configured to be releasably coupled to a coupling element 36 (see FIG. 5a-5c), for example in the form of a pin, being arranged on the movably-mounted furniture part 3. For applying a force to the entrainment member 14 in a direction opposite to the extension direction 31 (see FIG. 3a-3c), a spring device 16 is provided which preferably includes at least one helical spring in the form of a tension spring. For increasing the spring force, the spring device 16 can also include two or more tension springs switched in parallel relationship. The spring device 16 has a fastening location 18 for connecting to a spring holder 17 which is separate from the entrainment member 14. The other end 19 of the spring device 16 is stationarily arranged in the mounting position (for example fixedly anchored to the carcass rail 11 of the drawer pull-out guide 10). Alternatively, it is possible that the retraction device 13 is arranged on the displaceable extension rail 12 so as to be displaceably arranged relative to the carcass rail 11, wherein the entrainment member 14 can be releasably coupled to a coupling element 36 arranged on the carcass rail 11.

For coupling a movement between the entrainment member 14 and the fastening location 18 of the spring device 16 on the spring holder 17, a coupling device 30 is provided which includes at least one control element 22 having a longitudinal axis 23. The control element 22 pivots about said longitudinal axis 23 when the entrainment member 14 is pulled outwardly, wherein the control element 22, upon a movement of the entrainment member 14 towards the extension direction 31, performs a rotational movement about the longitudinal axis 23 and a translational movement along the longitudinal axis 23. The control element 22 includes at least one first guide element 22a which, upon extending the entrainment member 14 towards the extension direction 31, is guided, at least over a region, along a first guide track 21. In the shown figure, the guide track 21 is formed or arranged on a first sleeve 20 and includes a first section 21a extending in the extension direction 31 and a helically-shaped second section 21b adjoining the first section 21a. When the entrainment member 14 is pulled outwardly, starting from the closed end position of the movable furniture part 3, the first guide element 22a of the control element 22 is guided along the first section 21a, wherein there are equal movement ratios between the entrainment member 14 and the fastening location 18 of the spring device 16. At the end of the extension movement of the entrainment member 14, the first guide element 22a is guided along the helically-shaped second section 21b of the first guide track 21, whereby the control element 22 is guided with a movement-component transverse to the extension direction 31. In this way, the position of the fastening location 18 of the spring device 16 falls back relative to a position of the entrainment member 14 moving towards the extension direction 31, so that the movement of the fastening location 18 is decelerated relative to the movement of the entrainment member 14. As a consequence, the spring device 16 is not stressed to its maximum extent, so that the effect of the sudden spring separation force is prevented when the entrainment member 14 is decoupled from the movable furniture part 3.

On the opposing end region of the control element 22, a second guide element 22b is arranged, the second guide element 22b is spaced from the first guide element 22a in the direction of the longitudinal axis 23. The second guide element 22b is displaceably arranged along a second guide track 25, and the second section 21b of the first guide track 21 and the second guide track 25, at least over a region, have an opposite sense of helix. The helically-shaped second guide track 25 is formed on a second sleeve 24, wherein the first sleeve 20 and the second sleeve 24 are connected to one another in a non-rotatable manner. This can be achieved by a limb 26 arranged on the second sleeve 24, wherein the limb 26 engages into a corresponding lengthy recess 27 of the first sleeve 20. Accordingly, the first sleeve 20 is arranged so as to be stationary, while the second sleeve 24 can solely be displaced relative to the first sleeve 20, but not rotated. The control element 22 is guided by the two guide elements 22a, 22b along the two guide tracks 21, 25 of the sleeves 20, 24, wherein the control element 22, when the first guide element 22b interacts with the helically-shaped section 21b of the sleeve 20, pivots about the longitudinal axis 23 and, as a consequence, brings about a decelerated movement of the fastening location 18 relative to the moving entrainment member 14.

FIG. 3a-3c show the retraction device 13 with different positions of the entrainment member 14 in the extension direction 31. FIG. 3a shows the retracted end position of the entrainment member 14, wherein the spring device 16 is substantially in a relaxed condition. The spring device 16 is connected to the spring holder 17 by the fastening location 18, wherein the spring holder 17 is connected to the guide element 22 by the coupling portion 28. The first guide element 22a is located on a first end of the first section 21a of the first guide track 21, while the second guide element 22b interacts with the helically-shaped second guide track 25 of the second sleeve 24. In the retracted end position of the entrainment member 14, the front faces of the two sleeves 20, 24 rest against each other, wherein the control element 22 is accommodated within the two sleeves 20, 24. In this way, a very compact structure is brought about.

FIG. 3b shows a slight extended position of the entrainment member 14 which, by manually applying a pulling force to the movable furniture part 3 towards the extension direction, is movable against the force of the spring device 16. The control element 22a is initially guided along the straight first section 21a of the first guide track 21 extending in the extension direction 31, wherein the fastening location 18 moves with the same speed as the entrainment member 14. The distance D (FIG. 4a, 4b) of the fastening location 18 relative to the entrainment member 14 remains, for the present, constant. After the position shown in FIG. 3b, the first guide element 22a interacts with the helically-shaped second section 21b of the first guide track 21. Thereby, the control element 22 is guided with a movement-component transverse to the extension direction 31, whereby the distance D1 (FIG. 4c) between the fastening location 18 and the entrainment member 14 is enlarged and thus the speed of the fastening location 18 is decelerated relative to the speed of the entrainment member 14. FIG. 3c shows the fully extended position of the entrainment member 14, wherein the first guide element 22a is located at the end of the second section 21b of the first guide track 21.

FIG. 4a-4c show side views of the retraction device 13 with different positions of the entrainment member 14 in the extension direction 31. The retraction device 13 has a housing 32 on which a linear displacement path 34 extending in the extension direction 31 for guiding the entrainment member 14 is arranged or formed. A bend 35, which preferably has a curved or edged configuration, for releasably locking the entrainment member 14 adjoins the linear displacement path 34. The entrainment member 14 is provided with a guide portion 33 by which the entrainment member 14 can be guided along the linear displacement path 34 and can be releasably coupled to the bend 35. Starting from the retracted end position of the entrainment member 14 according to FIG. 4a, the entrainment member 14—triggered by a manual pulling motion applied to the movable furniture part 3—is moved towards the extension direction 31, wherein the first guide element 22a of the control element 22 is moved along the straight first section 21a of the first guide track 21 extending in the extension direction 31. The distance D, which is present between the axis 15 of the entrainment member 14 and the first guide element 22a, remains initially constant. Starting from the extension position of the entrainment member 14 according to FIG. 4b, the first guide element 22a is moved along the helically-shaped second section 21b of the first guide track 21, whereby the fastening location 18 of the spring device 16 on the spring holder 17 falls back relative to the position of the entrainment member 14 moving towards the extension direction 31. Accordingly, the distance D1—in comparison with the distance D according to FIG. 4a and FIG. 4b—is enlarged. The guide portion 33 of the entrainment member 14 moves into the bend 35, whereby the entrainment member 14 pivots about the axis 15 and the notch 29 of the entrainment member 14 releases the coupling element 36 (FIG. 5a-5d) of the movable furniture part 3. The uncoupled movable furniture part 3 can subsequently be moved further towards the extension direction 31. In FIG. 4c, the entrainment member 14 is located in a self-locking arrested ready-position for a retraction process of the movable furniture part 3 in a direction opposing the extension direction 31. Upon closing the movable furniture part 3, the furniture part 3 can namely be coupled again to the notch 29 of the entrainment member 14, so that the guide portion 33 moves out of the bend 35 and the entrainment member 14 is again pulled into the retracted end position according to FIG. 4a by the force of the relaxing spring device 16.

FIG. 5a-5d show a further embodiment of a retraction device 13 having a pivotally-mounted entrainment member 14 in different retraction positions. Visible is a coupling element 36 to be fixed to the movable furniture part 3, the coupling element 36 can be releasably coupled to the entrainment member 14. The pivotable entrainment member 14 is coaxially arranged relative to the longitudinal direction 23 of the control element 22 and includes an inclined surface 37 extending transverse to the extension direction 31. When the inclined surface 37 interacts with the coupling element 36, the inclined surface 37 rotates the entrainment member 14 about the longitudinal axis 23, so that the control element 22 is also rotated therewith about the longitudinal axis 23 and the first guide element 22a of the control element 22 is being released from the locking position with the second section 21b of the first guide track 21. It is preferably provided that the entrainment member 14, together with the control element 22, has a one-piece configuration and is arranged on a slider 40 which is displaceably guided along a linear guide 38 of the housing 32 by bolts 39 arranged on the slider 40. The second guide track 25 is formed on the linearly displaceable slider 40, wherein the second guide track 25 interacts with the second guide element 22b of the control element 22.

When now the movable furniture part 3 is being closed (FIG. 3b), the coupling element 36 interacts with the inclined surface 37 of the entrainment member 14. In this way, the entrainment member 14 is pivoted about the longitudinal axis 23 and is coupled to the coupling element 36, wherein the first guide element 22a of the control element 22, by a pivotal movement of the control element 22 about the pivoting axis 23, is released from the locking position with the second section 21b of the first guide track 21 and wherein the entrainment member 14 which is coupled to the coupling element 36, together with the control element 22, is retracted in a direction towards the closed end position by the force of the discharging spring device 16 (FIG. 5c). The first guide element 22a now interacts with the first section 21a of the first guide track 21 extending in the extension direction 31, so that the entrainment member 14, together with the control element 22, is displaced along the longitudinal axis 23 in a direction towards the closed position, without performing a rotational movement. In FIG. 5c, also the end of the second section 21b of the first guide track 21 is visible, wherein said end of the second section 21b, for releasably locking the first guide element 22a, includes a portion extending at a right angle relative to the pivoting axis 23. Starting from the position of the entrainment member 14 shown in FIG. 5c, the entrainment member 14 can be retracted, together with the control pin 22, into the complete end position. When now the movable furniture part 3 is again opened, the entrainment member 14, starting from FIG. 5d, is again pulled outwardly by the coupling element 36 towards the extension direction 31, wherein the control element 22, at the end of this extension movement, rotates again about the pivoting axis 23 by the guide elements 22a, 22b interacting with the guide tracks 21, 25, so that the entrainment member 14 is also being rotated about the pivoting axis 23 and the coupling element 36 is being released from the entrainment member 14 for the further extension movement.

1. A retraction device for retracting a movably-mounted furniture part into a closed end position relative to a furniture carcass, including:
an entrainment member which can be releasably coupled to the movable furniture part,
at least one spring device for applying a force to the entrainment member in a direction opposite to an extension direction of the entrainment member, wherein the spring device can be tensioned in the extension direction of the entrainment member by a spring holder which is separate from the entrainment member,
a coupling device for coupling a movement between the entrainment member and the spring holder, wherein by the coupling device, the distance of a fastening location of the spring device on the spring holder relative to the entrainment member varies upon extending the entrainment member towards the extension direction,
wherein the coupling device includes at least one control element having a longitudinal axis extending in the extension direction, wherein for varying the distance which is present between the fastening location and the entrainment member, the control element pivots at least partially about the longitudinal axis upon extending the entrainment member towards the extension direction.

2. The retraction device according to claim 1, wherein the control element includes at least one first guide element which is guided, at least over a region, along a first guide track upon extending the entrainment member towards the extension direction.

3. The retraction device according to claim 2, wherein the first guide track includes a first section extending in the extension direction of the entrainment member, and a helically-shaped second section adjoining the first section.

4. The retraction device according to claim 2, wherein the control element includes at least one second guide element which is guided, at least over a region, along a second guide track upon extending the entrainment member towards the extension direction.

5. The retraction device according to claim 4, wherein the second guide track is helically-shaped at least over a region.

6. The retraction device according to claim 4, wherein the first guide element and the second guide element are spaced from each other along the longitudinal axis of the control element.

7. The retraction device according to claim 4, wherein the first guide track is formed or arranged on a first sleeve and that the second guide track is formed or arranged on a second sleeve.

8. The retraction device according to claim 7, wherein the first sleeve and the second sleeve are connected to one another in a non-rotatable manner.

9. The retraction device according to claim 8, wherein the first sleeve and the second sleeve are connected to one another in a non-rotatable manner by at least one limb.

10. The retraction device according to claim 7, wherein the control element and/or the spring device, upon extending the entrainment member towards the extension direction, is or are guided, at least over a region, within the first sleeve or second sleeve.

11. The retraction device according to claim 4, wherein the first guide track and the second guide track, at least over a region, have an opposite sense of helix.

12. A drawer pull-out guide having a retraction device according to claim 1.

13. The drawer pull-out guide according to claim 12, wherein the drawer pull-out guide includes a carcass rail to be fixed to a furniture carcass and at least one extension rail displaceable relative to the carcass rail, wherein the extension rail, at the end of the closing movement, can be retracted into the fully closed end position by the retraction device.

14. An arrangement with a movable furniture part, in particular a flap, a door or a drawer, and with a retraction device according to claim 1 for retracting the movable furniture part into the closed end position relative to a furniture carcass.
